(19) United States
(12) Patent Application Publication
(10) Pub. No.: US 2024/0255021 A1
(43) Pub. Date: Aug. 1, 2024

(54) Journal bush as part of an oil film bearing

(71) Applicant: SMS group GmbH, Düsseldorf (DE)

(72) Inventors: Johannes ALKEN, Siegen (DE); Daniel KNIE, Freudenberg (DE); Andrej TUCAK, Wenden-Brün (DE)

(73) Assignee: SMS group GmbH, Düsseldorf (DE)

(21) Appl. No.: 18/560,914

(22) PCT Filed: Apr. 28, 2022
(86) PCT No.: PCT/EP2022/061370

§ 371 Date: Nov. 14, 2023

(30) Foreign Application Priority Data
May 21, 2021 (DE) 10 2021 205 276.2

(51) Int. Cl. F16C 17/10; B21B 31/07

(52) U.S. Cl. CPC F16C 17/105; B21B 31/074; F16C 2322/12

(57) ABSTRACT

An oil film bearing includes a journal bush and accommodates a conical roll journal of a backup roll in a rolling mill stand. In order to form a sufficiently large lubricant film gap between the inner side of the journal bush and the outer surface of the roll journal during rolling operation when passing through the angular range with maximum pressure load, and at the same time to prevent the axial forces acting on a fastening ring holding the journal bush on the roll journal in the axial direction from becoming too great, the journal bush to be designed in accordance with the following formula: 0.35<3.6/a (D−B)+kD<0.5, where D refers to the outer running diameter of the journal bush, a refers to the projected cone length of the conical longitudinal portion, k refers to a sliding coefficient, and B refers to the large cone diameter.

### CROSS-REFERENCE TO RELATED APPLICATION

This application is a national stage application, filed under 35 U.S.C. § 371, of International Patent Application PCT/EP2022/061370, filed on Apr. 28, 2022, which claims the benefit of German Patent Application DE 10 2021 205 276.2, filed on May 21, 2021.

### BACKGROUND

In the prior art, journal bushes of oil film bearings are generally known.

The patent application publication DE 2843658 A1 describes the design of a conical journal bush as being advantageous in that the bearing can be more easily fitted to or removed from, as the case may be, the likewise conical roll journal during maintenance work. This relatively tight fit of the conical journal bush on the conical roll journal is not so tightly fitted that limited relative rotation of the journal bush to the roll journal cannot occur. Such minute relative rotations (also referred to as “micreep” in DE 2843658) can lead to microscopic wear (“fretting”) on the contact surfaces. Permanent damage to the rotating components, in particular to the surface of a roll journal, can be the result.

The invention in accordance with DE 2843658 A1 has set itself the object of creating an improved device for lubricating the transition between the roll journal and the co-rotating journal bush, without disadvantageously withdrawing too much oil for the function of the oil film bearing from the load zone. This is achieved by additional secondary lubrication grooves arranged on the inner side of the rotating journal bush, which are fed with oil from the primary lubrication grooves. A plurality of groove networks distributed around the circumference in this manner and separated from one another promote lubrication of the contact surfaces between the roll journal and journal bush.

In the patent specification WO 2011/096672, a further method/device for arranging lubrication grooves in an oil film bearing for rolling mill rolls is presented.

In EP 1213061 B1, a thin-walled journal bush is presented that, due to its greater elastic deformation under load compared with the prior art at that time, aims to achieve an increased load-bearing capacity. A minimum taper angle of 3 degrees is specified for the cone, below which “self-locking” occurs, and a minimum (thinnest) journal bush thickness of 10 mm to 0.024 D+14.5 (D=running diameter of the bearing) is specified, which is placed on an externally tapered portion of the roll journal.

The increase in load-bearing capacity referred to in this patent (the specialist refers to this as EHD; elasto-hydro-dynamic increase in load-bearing capacity) results from the fact that, under radial load (oil pressure in the load zone), the journal bush can be displaced axially away from the roller body. Such displacement is limited by a fastening unit at the tapered end of the roll journal, such as those described in the patents DE102016214011A1, DE102017217562A1. In addition, simulative investigations show that such axial sliding of the journal bush (caused by the downward slope force on the conical taper angle) does not occur uniformly around the circumference but is maximized when rotationally passing through the load zone. Such circumferentially varying sliding of the journal bush results in a sinusoidal back and forth sliding of the two friction pairs, which ensures that oil can also reach the contact surfaces between the roll journal and the journal bush via the oil lubrication grooves (described above), where no lubrication grooves are arranged. (Thus between the lubrication grooves).

### SUMMARY

The disclosure relates to a journal bush as part of an oil film bearing in a rolling mill stand. The journal bush serves to accommodate the conical roll journal of a roll, in particular a backup roll of the rolling mill stand. The oil film bearing with the journal bush is used for mounting the roll in the rolling mill stand. The rolling mill stand is typically used for cold or hot rolling of metallic rolling product in a rolling mill.

Due to the sliding of the journal bush, axial forces arise in the fastening unit, which must be supported or held, as the case may be, by the roll journal end. The magnitude of such axial forces (downward slope forces) is directly related to the conical taper angle. In practice, it has been shown that, due to the design, damage can occur at the end of the roll (where the axial force is absorbed by the roll) if the angles are too large. This results in a contrary design goal:
The journal bush must slide axially so far that the lubricating medium (oil) added via lubrication grooves can reach the surfaces located between the lubrication grooves sufficiently; and
The journal bush must not exert excessive forces on the axial fastening unit so that it is not damaged.

The disclosure is based on the object of further designing a known journal bush as part of an oil film bearing and a known rolling mill stand with the journal bush in such a manner that they meet the two aforementioned conflicting design objectives.

This object is achieved by journal bush as part of an oil film bearing in a rolling mill stand for accommodating a conical roll journal of a roll, in particular a backup roll. The journal bush is elastically deformable under the action of a rolling force exerted by the rolling mill stand and is cylindrically shaped on its outer side with an outer running diameter D. The journal bush has an inner conical longitudinal portion that is conically shaped on its inner side over a cone length (a) with a large cone diameter (B) and a cone angle (β) for accommodating the conical roll journal of the roll. The conical longitudinal portion has lubrication grooves on its inner side for introducing lubricant into the intermediate space between the inner side of the journal bush and the outer side of the conical roll journal. The following applies for the journal bush:

$$0.35 < \frac{3.6}{a} ( D - B ) + k D < 0.5 \qquad ( 1 )$$

with
a [m] conical length of the journal bush,
D [m] outer running diameter of the journal bush,
B [m] large cone diameter of the journal bush; and

$$\begin{matrix}k = 0. 15 [ 1 / m ] & sliding coefficient\end{matrix} .$$

Preferably, the value for the lower limit is 0.37 and/or the value for the upper limit is 0.49.

It is to the credit of the inventors to have found out that journal bushes that fulfill the newly claimed design condition in accordance with formula (1) also achieve the object of the disclosure. This means that, in the case of such journal bushes, sufficient lubricating oil reaches the region between the roll journal and journal bush in rolling operation under the action of large rolling forces due to an angle-position-dependent axial journal bush displacement or deformation, as the case may be, on the one hand, such that no damage whatsoever occurs there to the surface of the roll journal. Furthermore, in the case of journal bushes designed in accordance with formula 1, the axial forces arising during elastic axial journal bush displacement or deformation, as the case may be, due to rolling forces of usual magnitude are advantageously tolerable; i.e. they lie within a permissible range of forces. The axial forces from such range of forces can be absorbed by a fastening device with an associated spring ring. In other words: With the journal bushes designed in accordance with the disclosure, the axial forces occurring in the event of journal bush displacement or deformation, as the case may be, are so low that there is no risk of the end of the roll journal tearing away from the rest of the roll journal because the (axial) forces introduced into it by the fastening system are too great, or that the fastening systems themselves would be overloaded or damaged, as the case may be. The spring rate of the spring ring must be designed in such a manner that, when the bearing is subjected to maximum load, the downward slope force that then arises (calculated with a known cone angle) results in a minimum axial displacement of the journal bush of 1/10 mm, preferably 3/10 mm.

In accordance with one exemplary embodiment, the conical journal bush has at least one groove on its inner side, as does the conical roll journal on its outer side, for partially accommodating a feather key. The feather key engages in both grooves and thus forms a rotational coupling in the circumferential direction between the roll journal and the journal bush that is fitted on it and rotates with it. At least one of such two grooves of each pair of grooves is dimensioned such that the feather key is seated in the grooves with an axial clearance and/or with a radial clearance. The two clearances facilitate or enable, as the case may be, the described axial displacement or deformation, as the case may be, of the journal bush if it passes through the region with the highest load during rolling operation.

The above-mentioned object is further achieved by a rolling mill stand as described herein. The advantages of this solution correspond to those mentioned above with respect to the claimed journal bush.

Further advantageous embodiments of the journal bush and the rolling mill stand are the subject of the dependent claims.

### BRIEF DESCRIPTION OF THE DRAWINGS

The description is accompanied by 5 figures, wherein

FIG. 1 shows a longitudinal section through the journal bush;

FIG. 2 shows the permissible range for the dimensioning of the journal bush;

FIG. 3 shows a longitudinal section of the journal bush without loading by a rolling force in conjunction with a feather key;

FIG. 4 shows a typical pressure distribution on the journal bush surface in an oil film bearing when loaded by a rolling force; and

FIG. 5 shows a longitudinal section through the journal bush and the roll journal mounted therein under load from the rolling force.

### DETAILED DESCRIPTION

The invention is described in detail below with reference to the figures in the form of exemplary embodiments. In all figures, the same technical elements are designated with the same reference signs.

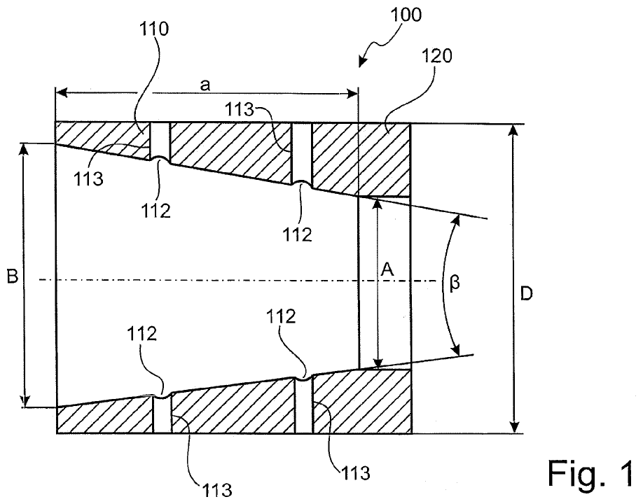

FIG. 1 shows the journal bush 100 in a longitudinal section. It has a cylindrical outer circumference and, together with a bearing bush, in a cylindrical cavity of which it is accommodated, forms an oil film bearing; not shown in FIG. 1. The lubricant gap of the oil film bearing filled with lubricant is located between the bearing bush and the journal bush.

The journal bush consists of a conical longitudinal portion 110, the length of which projected onto the cylindrical outer circumference of the journal bush is designated by the reference sign a. The conical longitudinal section 110 spans a conical cavity with a large cone diameter B and a small cone diameter A. The conical longitudinal portion 110 has a cone angle β. In the region of the small cone diameter A, a cylindrical end portion 120 of the journal bush seamlessly adjoins the conical longitudinal portion 110. The end portion 120 spans a cylindrical cavity whose diameter corresponds to the diameter of the small cone diameter A.

Both the conical cavity spanned by the conical longitudinal portion 110 and the cylindrical cavity adjoining it and spanned by the end portion 120 are used for accommodating a corresponding complementarily formed journal of a roll in a rolling mill stand. The outer diameter of the externally cylindrical journal bush is D. The cylindrical outer side of the journal bush is connected to lubrication grooves 112 on the inner side of the journal bush via connecting channels 113.

During operation of the roll mounted in this manner, the specified lubricating film from a lubricant is formed between the bearing bush and the outer side of the journal bush 100. The lubricant enters the lubrication grooves 112 via the connecting channels 113. However, as long as the journal bush 100 is tightly fitted on the roll journal, the lubricant remains in the lubrication grooves 112 and cannot spread from there into the contact surface between the journal bush and the roll journal.

The following applies to the journal bush 100:

$$0.35 < 3.6 / a ( D - B ) + k * D < 0.5 \qquad ( 1 )$$

with
B [m] large cone diameter
D [m] outer running diameter
a [m] length of the conical longitudinal portion projected onto the cylindrical outer circumference of the journal bush

$$\begin{matrix}k = 0. 15 [ 1 / m ] & sliding coefficient\end{matrix} .$$

Preferably, the lower limit is 0.37 (instead of 0.35) and/or the upper limit is 0.49 (instead of 0.5).

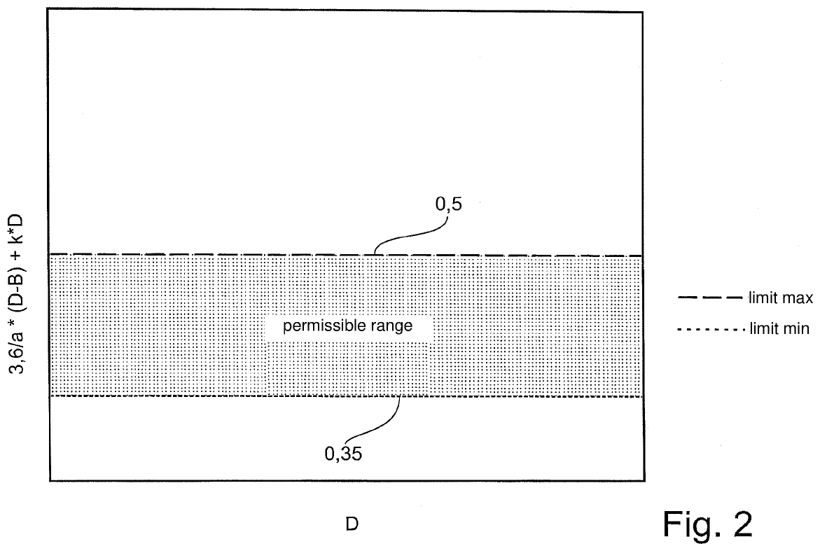

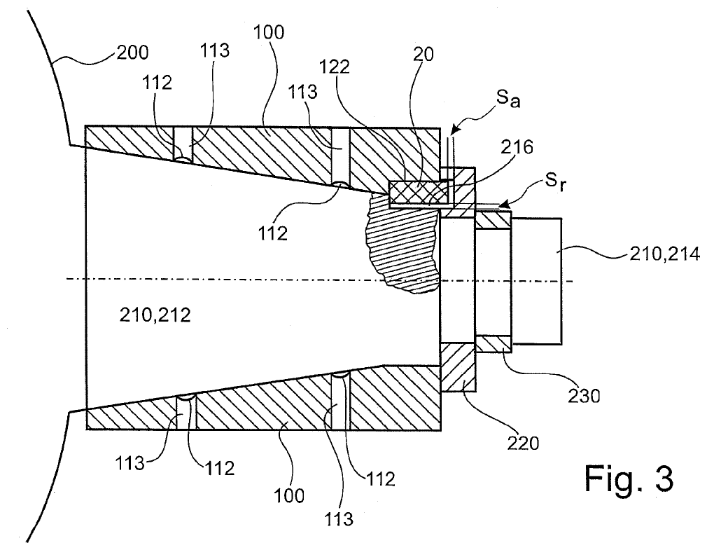

The claimed lower and upper limits are clearly shown in FIG. 2. They span a range that is permissible in the design. That is, as long as a journal bush satisfies the claimed formula (1) with the claimed upper and lower limits, preferably with the enlarged lower limit and/or with the reduced upper limit, the journal bush satisfies the object underlying the invention, i.e., the contrary design objective to be achieved. Such contrary design objective and its solution in accordance with the invention are explained again in more detail below with reference to FIGS. 3 to 5.

FIG. 3 shows a supplement to FIG. 1. In FIG. 3 as well, the journal bush 100 is tightly fitted to the roll journal 210. That is, the conical longitudinal portion 110 of the journal bush 100 is seated without a gap on the substantially complementary conical roll journal portion 212, and the cylindrical end portion 120 of the journal bush is seated on the cylindrical roll journal end portion 214 of the roll journal. There is a basic frictional connection between the journal bush 100 and the roll journal 210; i.e., the journal bush 100 rotates with the roll journal 210 due to the existing static friction. The rotational, frictional coupling is secured by at least one feather key 20, one part of which is seated in an axially aligned groove 122 on the inner side of the journal bush and another part of which is seated in a groove 216 running in the axial direction on the outer side of the roll journal. The feather key 20 is seated in such two grooves 122, 216 with axial clearance Sa and/or with radial clearance Sr.

In the axial direction, the journal bush 100 is secured on the roll journal firstly by a spring ring 220 and secondly by a fastening ring 230.

FIG. 3 shows the constellation of journal bush and roll journal in an unloaded state, i.e. without the action of a rolling force or under the action of a rolling force that is, however, so low that it does not lead to deformation of the journal bush. In this state, no lubricating film is formed between the journal bush and the roll journal.

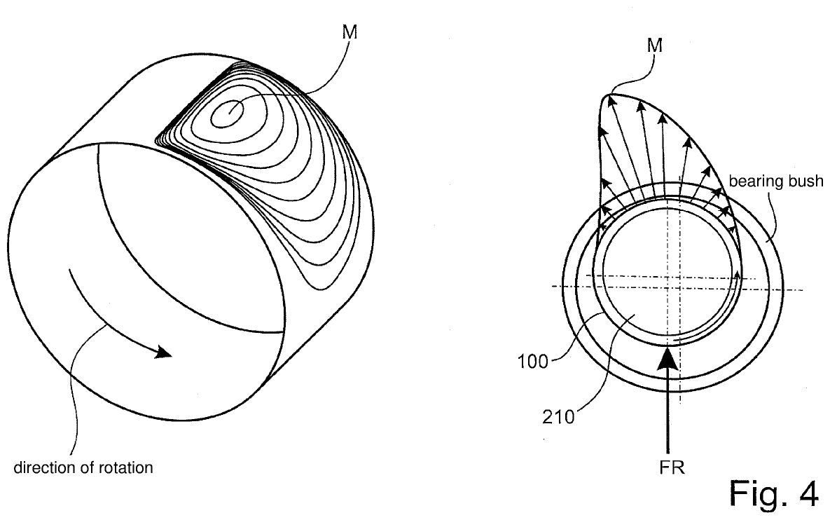

FIG. 4 shows the real pressure distribution as it arises in the bearing gap between the rotating journal bush and the stationary bearing bush during rolling operation. As an example, the pressure distribution is shown here for the case where an upper backup roll journal 210 with a fitted journal bush 100 is rotatably supported in a rolling mill stand and rotates in the direction of the arrow during rolling operation; see left and right images in FIG. 4. It is important to recognize that the pressure load for the bearing and in particular the journal bush is by no means evenly distributed over the circumference, but that a maximum load M is formed in the region of the surface of the journal bush opposite the rolling force action FR.

The pressure distribution shown in FIG. 4 is substantially stationary in a circumferential angular range during rolling operation, at least as long as the direction in which the rolling force FR is acting does not change. This is not contradicted by the fact that the rolling force can in principle change its amount.

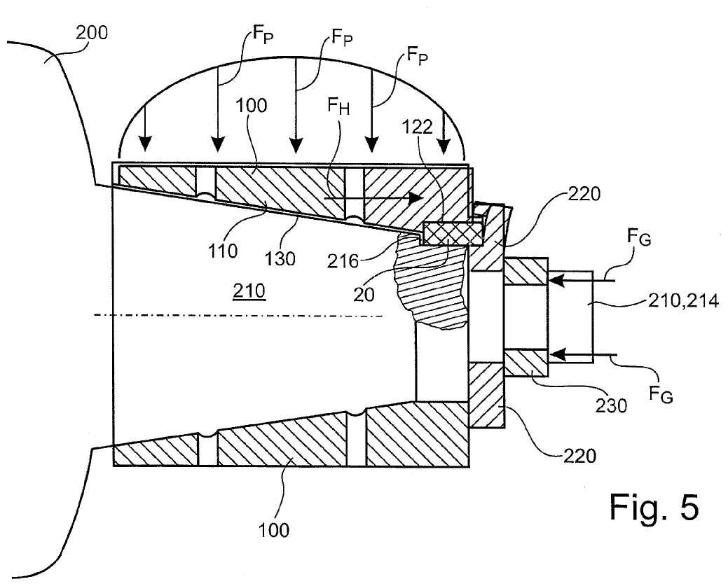

The consequence of the specified stationary pressure distribution is that a point on the surface of the roll journal or the co-rotating journal bush, as the case may be, is only subjected to the large pressure load shown if it passes through the pressure range with the large maximum pressure load M shown in FIG. 4 during its rotation. In this situation, i.e. when passing through the angular range with the large pressure load, the compressive force FP on the journal bush in the radial direction resulting from the rolling force FR and, in particular, the downward slope force FH resulting therefrom in conjunction with the conical longitudinal portion 110 can become so large that the journal bush 100 is displaced or deforms locally, as the case may be, as shown in FIG. 5. The local deformation consists in the fact that in particular the part of the journal bush that currently passes through the region of the large pressure load M during rotation is displaced or deforms, as the case may be, on the roll journal in the direction of the downward slope force FH and thus detaches locally from the roll journal.

The detachment of the journal bush from the roll journal 210 takes place with the formation of a microscopically narrow and locally limited lubricant gap 130 between the journal bush 100 and the roll journal 210. Such microscopically narrow lubricant gap 130 also does not extend over the entire circumference at all, but is substantially restricted in the circumferential direction to the region of high pressure loading shown in FIG. 4. Thus, when passing through the angular range of large pressure load M, lubricating oil is forced from the actual lubricating film between a bearing bush and the journal bush 100, as shown in FIG. 4, through the connecting channels 113 into the lubrication grooves 112 and from there into the specified lubricating gap 130, as shown in FIG. 5. The part of the journal bush 100 passing through the angular range of large pressure load deforms due to the compressive force FP, as also shown in FIG. 5, in such a manner that it slides on the lubricant film 130 and presses against the spring ring 220, deforming the latter as well. During the deformation/displacement, the axial and radial clearance Sa, Sr of the feather key 20 in the groove 122 in the journal bush and/or in the groove 216 in the roll journal is utilized by pressing the feather key into its limitation due to the displacement of the roll journal in accordance with FIG. 5.

It is noteworthy that the journal bush on the opposite side, at the bottom in FIG. 5, is only slightly deformed and thus is seated almost unchanged with an interference fit without a lubricant gap on the roll journal.

The design of the journal bush 100 in accordance with formula (1) ensures that, on the one hand, the specified lubricant gap 130 is formed, which ensures that the lubricating oil between the journal bush and the roll journal is not restricted locally to the region of the lubrication grooves 112, but is also distributed into the regions between the lubrication grooves 112. This is desired, despite the still existing basic tight fit of the journal bush on the roll journal, in order to prevent the fretting known from the prior art, i.e. the microscopic wear that would otherwise arise in the region of the contact surfaces between journal bush and roll journal when passing through the angular range with the large pressure load. Such wear is prevented by the lubricant gap 130, which in turn is realized or favored, as the case may be, by making the downward slope force FH as large as possible. In particular, the greater the difference between the large and small cone diameters B, A, the greater the downward slope force. On the other hand, however, the downward slope force FH must not become too great, because otherwise the spring ring 220 and the fastening ring 230 can no longer absorb the downward slope force FH and dissipate it into the roll journal 210. In the worst case, i.e., if the downward slope force FH were to become too large, the cylindrical roll journal end portion 214 can be blown off from the conical roll journal portion 212 in the axial direction.

As stated, the design of the journal bush 100 in accordance with formula (1) ensures that both conflicting design objectives can be realized or met, as the case may be.

The two arrows shown in FIG. 5 pointing from the right against the fastening ring 230 represent the counterforce FG to the downward slope force FH, which must be absorbed by the roll journal, in particular by the cylindrical roll journal end portion 214, if the downward slope force is dissipated into the roll journal 210 via the fastening ring 230.

### LIST OF REFERENCE SIGNS

100 Journal bush
110 Conical longitudinal portion
112 Lubrication groove
113 Connecting channel
120 End portion
122 Groove for feather key
130 Lubricant gap
20 Feather key
200 Roll
210 Roll journal
212 Conical roll journal portion
214 Cylindrical roll journal end portion
216 Groove for feather key
220 Spring ring
230 Fastening ring
A Small cone diameter
B Large cone diameter
D Outer running diameter of the journal bush
M Maximum load
Sa Axial clearance
Sr Radial clearance
β Cone angle
FG Counterforce to the downward slope force FH
FP Compressive force resulting from the rolling force FR
FR Rolling force
FH Downward slope force
a (Projected) cone length of the conical longitudinal portion

1.-7. (canceled)

8. A journal bush (100) being part of an oil film bearing in a rolling mill stand for accommodating a conical roll journal of a roll,
wherein the journal bush is elastically deformable under action of a rolling force exerted by the rolling mill stand, and
wherein the journal bush is cylindrically shaped on its outer side with an outer running diameter (D), and
wherein the journal bush has an inner conical longitudinal portion (110) that is conically shaped on its inner side over a cone length (a) with a large cone diameter (B) and a cone angle (β) for accommodating the conical roll journal of the roll, and
wherein the inner conical longitudinal portion (110) has lubrication grooves (112) on its inner side for introducing lubricant into an intermediate space between the inner side of the journal bush and an outer side of the conical roll journal, and
wherein the following applies for the journal bush (100):
$$0.35 < \frac{3.6}{a} ( D - B ) + k D < 0.5 \qquad ( 1 )$$
with k=0.15/m being a sliding coefficient.

9. The journal bush (100) according to claim 8,
wherein the following applies for the journal bush (100):
$$0.37 < \frac{36}{a} ( D - B ) + k D < 0.49 \qquad ( 2 )$$

10. The journal bush (100) according to claim 8,
wherein a hollow-cylindrical shaped end portion (120) joins the inner conical longitudinal portion at a location of a smallest cone diameter (A) thereof, and
wherein an inner diameter of the hollow-cylindrical shaped end portion (120) is aligned with the inner conical longitudinal portion at the location of the smallest cone diameter (A).

11. The journal bush (100) according to claim 8,
wherein the journal bush (100) has a groove (122) on its inner side for partially accommodating a feather key (20).

12. A rolling mill stand comprising,
at least one bearing housing, which is formed as an oil film bearing having the journal bush (100) according to claim 8; and
at least one roll (200) having a roll journal (210) formed with a conical roll journal portion (212),
wherein the journal bush is rotatably mounted with the roll journal in the bearing housing.

13. A rolling mill stand comprising,
at least one bearing housing, which is formed as an oil film bearing having the journal bush (100) according to claim 8; and
at least one roll (200) having roll journals (210) formed with a conical roll journal portion (212) and a cylindrical roll journal end portion (214) for being accommodated in the journal bush (100),
wherein the journal bush is rotatably mounted with the roll journal in a bearing bush in the bearing housing.

14. The rolling mill stand according to claim 12,
wherein the roll journal (210) has a first of two grooves (216) on its outer side;
wherein a feather key (20) is provided,
a first part of which is accommodated by a second of the two grooves (122) on the inner side of the journal bush (100) and
a second part of which is accommodated by the first of the two grooves (216) on the outer side of the roll journal (210); and
at least one of the two grooves is dimensioned with respect to dimensions of the feather key (20) in such a manner that the feather key (20) is seated in the two grooves in a load-free state, outside rolling operation, with an axial clearance of Sa>0.0 mm and with a radial clearance Sr>0.5 mm.

15. The rolling mill stand according to claim 14,
wherein the journal bush (100) is secured on the roll journal in an axial direction by a fastening ring (230) and a spring ring (220) arranged in the axial direction between the journal bush (100) and the fastening ring (230) against slipping off the roll journal (210) in the axial direction; and
wherein a spring rate of the spring ring (220) is designed such that, when the bearing is subjected to maximum load, a downward slope force that then arises, calculated with a known cone angle, results in a minimum axial displacement of the journal bush of 3/10 mm.
